(19) United States
(12) Patent Application Publication
(10) Pub. No.: US 2013/0325828 A1
(43) Pub. Date: Dec. 5, 2013

(54) System and Method For Providing High-Availability and High-Performance Options For Transaction Log

(71) Applicant: Confio Corporation, (US)

(72) Inventors: Matthew Donald Larson, Erie, CO (US); Brett Derek Hawton, Alamo, CA (US)

(73) Assignee: Confio Corporation, Boulder, CO (US)

(21) Appl. No.: 13/837,630

(22) Filed: Mar. 15, 2013

Related U.S. Application Data
(60) Provisional application No. 61/646,802, filed on May 14, 2012.

(51) Int. Cl. G06F 17/30

(52) U.S. Cl. CPC G06F 17/30371
USPC 707/703

(57) ABSTRACT

The present invention provides a method and system for using an operating system level I/O filter driver for providing transparent database transaction log file redundancy. In accordance with the method, the I/O filter driver intercepts a database management system request to write data to the database transaction log file. The I/O filter driver writes the data to at least two transaction log files.

### CROSS-REFERENCE TO RELATED APPLICATION

This application claims the benefit of U.S. provisional patent application No. 61646802, filed May 14, 2012. U.S. provisional patent application No. 61646802 is specifically incorporated by reference herein.

### FIELD OF THE INVENTION

The present invention generally relates to computer database management system software and the method it uses to write and read its transaction log file. Specifically it relates to the use of an operating system I/O filter driver to intercept reads and writes by the database management system to its transaction log files to provide transaction log file redundancy.

### BACKGROUND OF THE INVENTION

The transaction log on the Microsoft SQL Server database management system (as well as on many other database management systems such as MySQL) contains all the changes made to the data in a database over a certain period of time.

The transaction log is used to ascertain just what data was changed on the database in order to undo or rollback either a specific transaction or indeed the entire database to a certain point in time. In the case where the database has been corrupted or destroyed then the transaction log can be used to recover and recreate the data changed in transactions since the last backup of the database was taken.

Despite the vital role played by the transaction log in recovery; on database management systems such as Microsoft SQL Server and MySQL (as well as others) there is a single point of failure where if the transaction log file itself becomes corrupted or lost then full data recovery is not possible.

### SUMMARY OF THE INVENTION

The present invention addresses the above needs by providing a method and system for using an operating system level I/O filter driver for providing database transaction log file redundancy. In accordance with the method, the I/O filter driver intercepts a database management system request to write data to the database transaction log file. The I/O filter driver writes the data to at least two independent transaction log files.

In accordance with another aspect of the present invention, a method for utilizing an operating system level I/O filter driver for transparently increasing database performance. The IO filter driver intercepts a database management system request to write data to the database transaction log file. The I/O filter driver determines if the user has specified that the write data is not to be written to the database transaction log file as recoverability of the specific data is not desired. If so, the I/O filter driver removes the write data from the data stream to be written to the database transaction log file.

In accordance with a further aspect of the present invention, an additional method for using an operating system level I/O filter driver for providing transparent database transaction log file redundancy. In accordance with this aspect of the invention, a user is allowed to specify database objects that are to be quick-logged. The I/O filter driver intercepts a database management system request to write data to the database transaction log file. The I/O filter driver determines if the write data contains only objects that the user has specified as being quick-logged. If so, the I/O filter driver writes data to at least two transaction log files after it reports to the operating system that the write request was successfully completed

Thus, the invention provides a method and system for providing transparent database transaction log file redundancy and provides benefits by the solving the problems in the prior art where the transaction log file is a single point of failure. By, transparently to the database management system, writing not just one single transaction log file but instead writing two or more identical transaction log files to independent file systems, the invention provides redundancy benefits to prevent the loss or corruption of the data in the transaction log file.

### BRIEF DESCRIPTION OF THE DRAWINGS

The foregoing aspects and many attendant advantages of this invention will become more readily appreciated by reference to the following detailed description, when taken in conjunction with the accompanying drawings, wherein:

FIG. 1 is a block diagram of a representative computer system environment in which the invention may be implemented;

FIG. 2 is a flow diagram illustrating an I/O filter driver routine for employing an operating system level I/O filter driver for providing transparent database transaction log file redundancy;

FIG. 3 is a flow diagram illustrating the I/O filter driver subroutine for writing at least two synchronized transaction log files;

FIG. 4 is a flow diagram illustrating an I/O filter driver subroutine for variable asynchronous writing of a transaction log file;

FIG. 5 is a flow diagram illustrating an I/O filter driver subroutine for verifying the writing of a transaction log file;

FIG. 6 is a flow chart illustrating the logic of a subroutine of the I/O filter driver process for reading one or more transaction log files.

### DETAILED DESCRIPTION OF THE PREFERRED EMBODIMENT

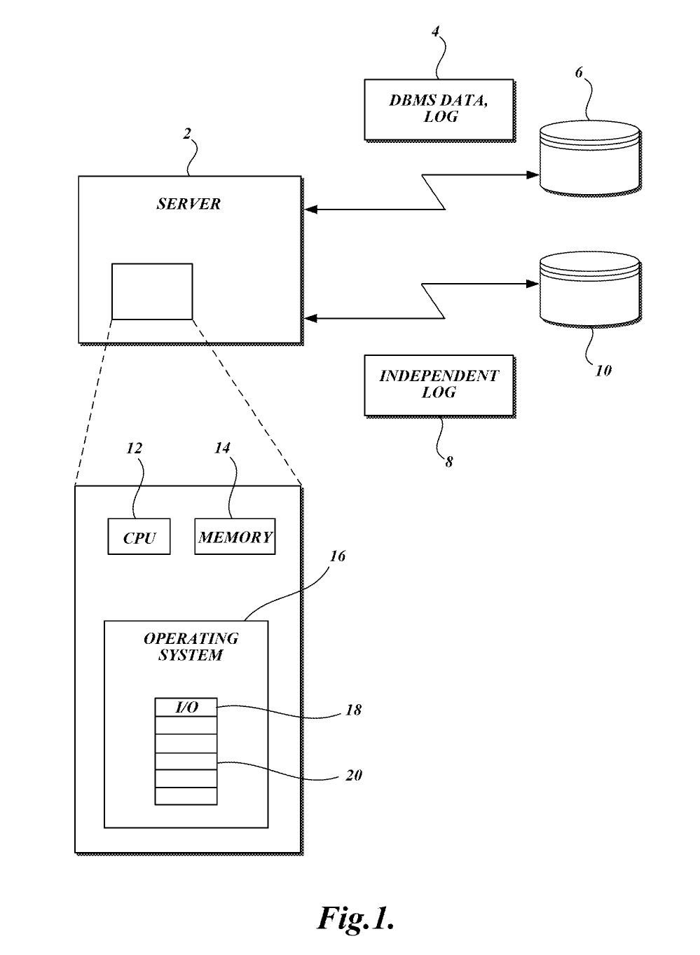

FIG. 1 illustrates an example of a suitable computing system environment in which the invention may be implemented. The computing system environment is only one example of a suitable computing environment and is not intended to suggest any limitation as to the scope of use or functionality of the invention. Neither should the computing environment be interpreted as having any dependency requirement relating to any one or combination of components illustrated in the exemplary operating environment.

The invention may be described in the general context of computer-executable instructions, such as program modules, being executed by a computer. Generally, program modules include routines, programs, objects, components, data structures, etc. that perform a particular task or implement particular abstract data types. The invention may also be practiced in distributed computing environments where tasks are performed by remote processing devices that are linked through a communications network. In a distributed computing environment, program modules may be located in both local and remote computer storage media, including memory storage devices.

With reference to FIG. 1, an exemplary system for implementing the invention includes a general-purpose computing device in the form of a server computer 2. Components of a server computer 2 include, but are not limited to, a central processing unit (CPU) 12, a system memory 14. The system memory 14 includes computer storage media in the form of volatile and/or nonvolatile memory, such as read-only memory and random-access memory. The server computer 2 may operate in a network environment using logical connections to one or more remote computers. The remote computer may be a personal computer, a server, a router, a network PC, a peer device or other common network node, and typically includes many or all of the elements described above relative to server computer 2. The logical connections include a local area network (LAN) and wide area network (WAN), but also include other networks. Such network environments are commonplace in office, enterprise-wide computer networks, intranets, and the Internet.

The server computer includes a list of FO device drivers 18, which are installed software routines for enabling the computer to transmit and receive data to and from input/output devices depending on the current situation. The server computer 2 is connected to computer data storage device 6 and computer data storage device 10. Computer data storage device 6 may store a database, which are files composed of records each containing fields together with a set of operations for search, sorting, recombining, and other functions. The database management system is a software interface between the database and the user. A database management system handles user requests for database actions and allows for control of security and data integrity requirements. The database management system is sometimes referred to by the acronym DBMS and is also sometimes called the database manager. A database server is a network node or station dedicated to storing and providing access to a shared database. The database machine is a peripheral that executes data set tasks, thereby relieving the main computer form performing them. A database machine is also referred to as a database server and performs only database tasks. A database structure is a general description of the format of records in a database, including the number of fields, specifications regarding the typed of data that can be entered in each field, and the fields names used.

Data storage device 6 may store a special type of database called relational database. A relational database is a database or database management system that stores information in tables—rows and columns of data—and conducts searches by using data in specified columns of one table to find additional data in another table. In a relational database the rows of a table represent records (collections of information about separate items) and the columns represent fields (particular attributes of a record). In conducting searches, a relational database matches information from a field in one table with information in a corresponding field of another to produce a third table that combines requested data from both tables.

The server computer 2 uses logical connections to one or more data storage devices to transmit information to the data storage devices. The information transmitted includes DBMS data and DBMS transaction log 4 to be stored in the database 6 and independent transaction log information 8 to be stored in data storage device 10. The logical connections include a local area network (LAN) and wide area network (WAN), but also include other networks. Such network environments are commonplace in office, enterprise-wide computer networks, intranets, and the Internet.

The server computer 2 includes an operating system 16, which is software that controls the allocation and usage of hardware resources such as memory, central processing unit (CPU) 12, disk space, and peripheral devices. The operating system is the foundation software on which applications depend. Popular operating systems include Windows 7, Windows Vista, Windows XP, Linux, Mac OS X, and Unix. The present invention installs an operating system level IO filter driver 20 which transparently intercepts all read and write requests the database management system (DBMS) makes to its transaction log files.

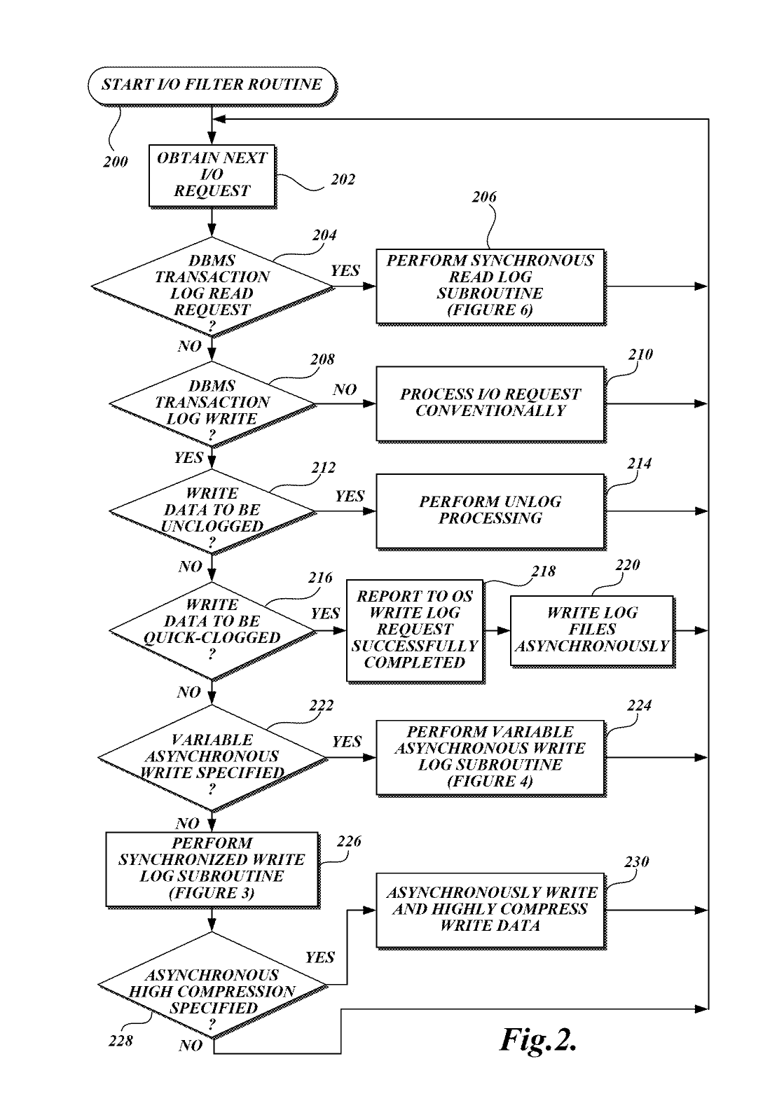

Generally described, FIG. 2 is a flow diagram illustrating an I/O filter driver routine for employing an operating system level I/O filter driver 20 for providing transparent database transaction log redundancy. The present invention utilizes an operating system level IO filter driver 20 for transparently intercepting all read and write requests the database management system (DBMS) makes to its transaction log files.

Referring to FIG. 2, at block 202 I/O filter driver Routine 200 obtains an I/O request. At block 204, a test is made to determine if the I/O request is a DBMS transaction log read request. The I/O filter driver Routine reads the I/O request data to determine what type of request is being made. If it is determined at decision block 204 that the I/O request is a DBMS read transaction log request, then the Read Log Routine is performed at block 206, which will be explained below (FIG. 8). After performing the Read Log Routine, Routine 200 returns to block 202 to obtain the next I/O request. If it is determined at decision block 204 that the I/O request was not a DBMS read request, then a test is performed to determine if the I/O request is a DBMS transaction log write request. If it is determined that the I/O request was not a DBMS write transaction log request then the I/O request is processed conventionally at block 210 and Routine 200 returns to block 202 to obtain the next I/O request.

One aspect of the present invention provides the user with the ability to specify that certain data is not to be logged. In the preferred embodiment, when the operating system level IO filter driver Routine 200 intercepts a write request to the transaction log file from the database management system, it determines if all of the underlying objects in the log write data have been marked by the user as not to be logged. If it is determined that the user has specified that the data is not to be logged, then the data is removed from the data stream to be written to the logs.

If it was determined that the I/O request was a DBMS request, then Routine 200 proceeds to decision block 212. At decision block 212 a test is made to determine if the I/O request write data contains changes for one or more tables or databases which the user has requested not to be logged. If it is determined that the write data contains non-logged data then Routine 200 performs un-log processing at block 214, where the non-logged data is expunged from the transaction log record to be written hence reducing the size of the data string to be written to the transaction log file. Non-logged operations are useful for dramatically speeding up the writes to tables whose data is transient in nature and hence does not need to be recovered. After performing non-logged process, Routine 200 returns to block 202 to obtain the next I/O request.

If it was determined at decision block 212 that the write data contains data to be logged, then Routine 200 continues to decision block 216, where a test is made to determine if the write data is to be quick-logged. This invention allows for a user to specify a “quick-log” operation for certain databases or tables in order to speed up their update performance. At decision block 212, a test is made to determine if the data to be written to the transaction log only contains changes for one or more tables or databases which the user has specified as candidates for quick-log. If it is determined that the write data is to be quick-logged, then Routine 200 proceeds to block 218 and immediately reports to the operation system that the data has been written successfully to the transaction log, so that the transaction is rapidly declared complete by the database. Next, the JO filter driver Routine 200 proceeds to block 220 to asynchronously write the data to one or more specified transaction log files. The ability at the operating system level to perform asynchronous tasks is well known by those of ordinary skill in the relevant art. Asynchronous operations are operations that proceed independently of any timing mechanism. An asynchronous procedures execute separately from an executing program and are called when a set of enabling conditions exist. In programming at the operating system level threads are utilized to perform independent tasks. A thread is a process that is part of a larger process and can be used to perform procedures asynchronously. After initiating asynchronous writing of the transaction log files at block 220, Routine 200 returns to block 202 to obtain the next I/O request.

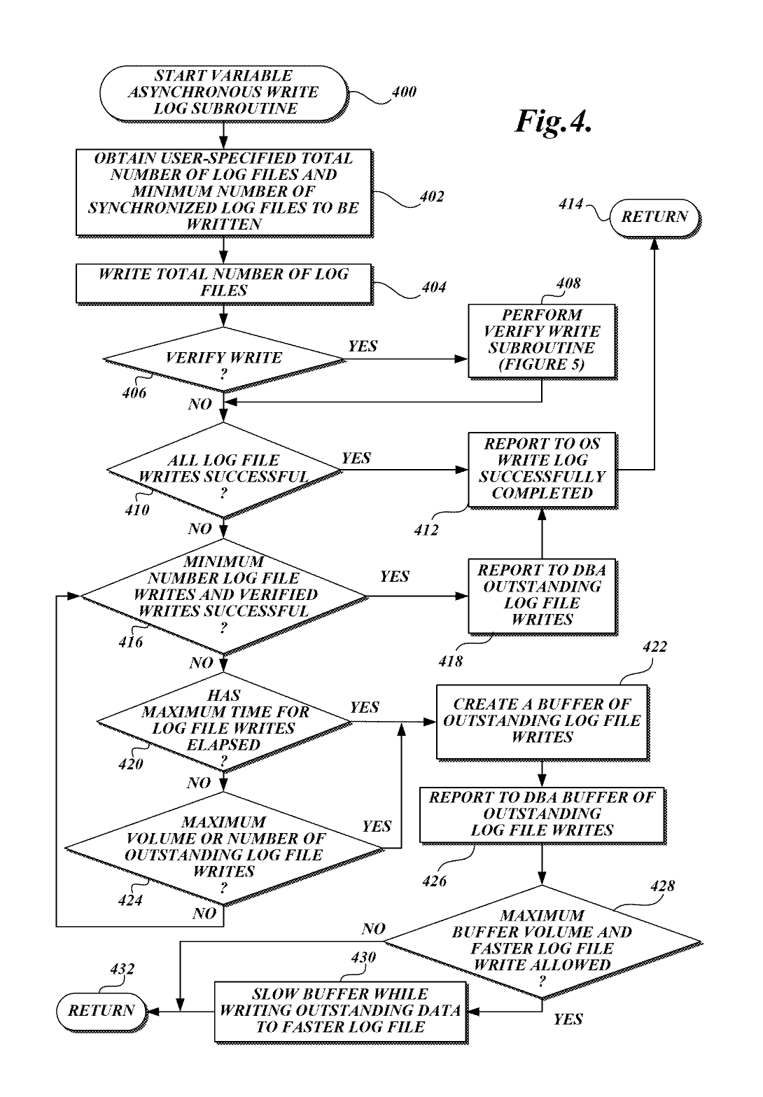

If at decision block 216 it was determined that the data to be written did not contain quick-log data then Routine 200 proceeds to decision block 222 where a test is made to determine if write data contains data that the user has specified to be written in a variable asynchronous manner. This invention allows the user to specify that varying degrees of asynchronous writes between the various transaction files are allowed. If it is determined that the use has specified the write data for variable asynchronous writes then Routine 200 proceeds to block 224 where the variable synchronous write Subroutine 400 is performed. The Variable Asynchronous Write Subroutine 400 is described below with reference to FIG. 4. Generally, the Variable Synchronization Write Subroutine 400 writes the data in varying degrees of asynchronous writes between the various transaction files. For example, in one embodiment, the user may specify that the Variable Synchronization Write Routine is to report that the transaction writes are complete after the write of any transaction log reports back as complete. After performing the Variable Asynchronous Write Subroutine at block 224, Routine 200 returns to block 202 to obtain the next I/O request.

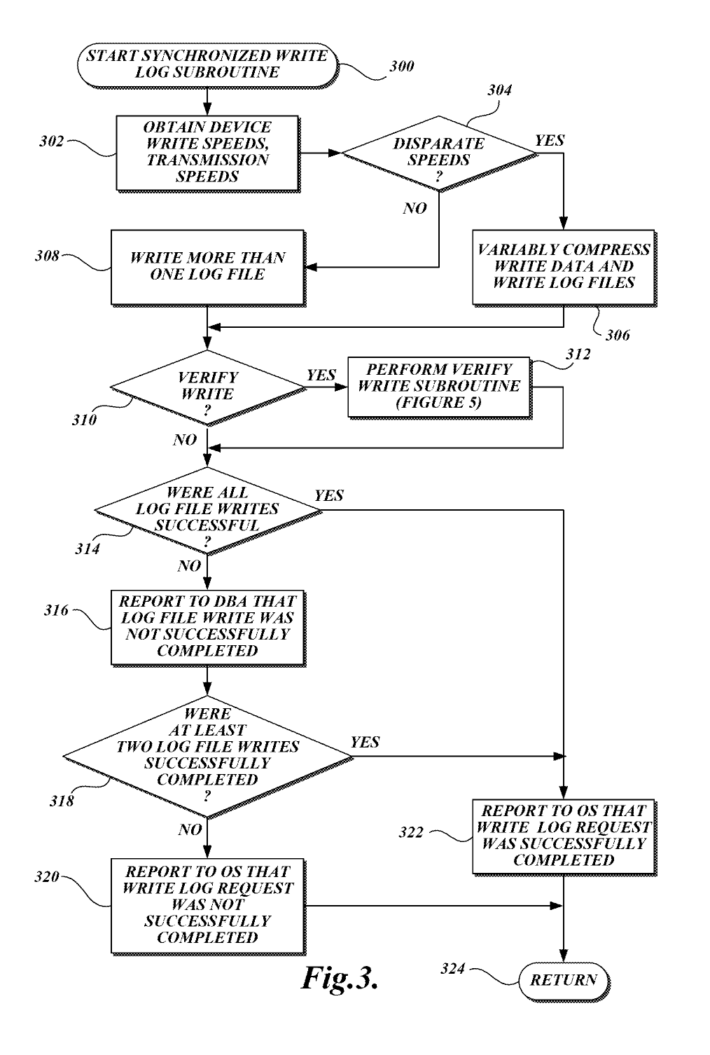

If at decision block 222 it was determined that the user did not specify variable asynchronous writes for the write data, then Routine 200 proceeds to block 226. At block 226 the Synchronized write log Subroutine 300 is performed. The Synchronized Write Log Subroutine 300 performs such that instead of the data being written to a single file it is copied and written to two or more independent transaction log files in order to provide redundancy and other benefits. The Synchronized Write Log Subroutine 300 is described below with reference to FIG. 3.

After performing the Synchronized Write Log Subroutine 300, Routine 200 proceeds to decision block 228 where a test is made to determine if the write data contains data that the user has selected for high compression asynchronous writes. In the preferred embodiment, this invention provides the ability to asynchronously, in the background, create a copy of the data recently written to a transaction log to a different transaction log file and to compress the copy to a far higher compression ratio whilst doing so. If at decision block 228 it is determined that the write data contains data the user has specified to be asynchronously compressed and written, then Routine 200 proceeds to block 230. At block 230, high compression asynchronous write processing is initiated. After being initiated by Subroutine 200, the processing continues to be performed asynchronously, in the background, by copying the data recently written to a transaction log to a different transaction log file and then compressing the copied data to a far higher compression ratio. This aspect of the invention will aid organizations where the copy of one log needs to be sent over a slow or expensive transmission medium such as a wide area network. After initiating the asynchronous high compression process at block 230, Routine 200 returns to block 202 to obtain the next I/O request and repeats the above described process. If at decision block 228 it was determined that the user did not specify asynchronous high compression of the write data, then Routine 200 directly returns to block 202 to obtain the next I/O request and repeat the above described process.

Referring now to FIG. 3, as generally described, is a flow diagram illustrating an I/O filter driver subroutine for employing an operating system level I/O filter driver 20 for providing transparent synchronized write database transaction log redundancy. The operating system level IO filter driver subroutine will intercept write requests to the transaction log file from any database management system. Instead of just writing the data to the one specified transaction log file, the present invention will instead write the same data to two or more disparate transaction log files potentially located on different input-output hardware media. Also, in the one embodiment, the transaction log file write is not reported back to the operating system as successful until all the transaction log file writes to the two or more disparate transaction log files have successfully completed.

Referring to FIG. 3, the Synchronized Write Log Subroutine 300 obtains device write speeds and transmission speeds at block 302. Subroutine 300 proceeds to decision block 304, where obtained information is evaluated to determine if device write speeds and transmission speeds differ significantly. When devices underlying the various transaction log files may have disparate write speeds or are connected to the database server via communication channels having different transmission speeds, it is possible and indeed likely that the writing of data to one transaction log file will be slower than the writing of the exact same data to a different transaction log file. In the event that the user wishes writes to the various transaction log files to happen in a synchronous fashion and all (or at least more than 1 transaction log file) to register as complete before the write is broadcast as complete to the database management system, then this invention deploys variable compression where the amount of compression of the data going to each transaction log is varied based on the write speed of the individual transaction log devices.

If it is determined at decision block 304 that the device and transmission speeds differ significantly, then the variable compression processing is performed at block 306. For disparate transaction log files that are demonstrating different write speeds, then in accordance with the preferred embodiment, the data to be written to each transaction log file is compressed by the ratio of its demonstrated write speed compared to the write speed of the other transaction log file, such that on transaction log files with fast writing abilities that the data is lightly compressed and on transaction log files with slow write abilities the data is compressed correspondingly more.

In the preferred embodiment, the data being written to a transaction log file which can write very quickly will be lightly compressed whereas the same data going to a slower transaction log file would be compressed more aggressively in order to reduce the size of the data string to be written and hence speed up its writes relative to the faster writing transaction log file. In accordance with the preferred embodiment, this variable compression may be constantly adjusted based on the write speeds of the various devices being fed into a standard proportional-integral-derivative (PID) algorithm controller in order to correctly damp the changes in a constant feed-back loop. The PID controller may alternatively use a Laplace transform to perform the damping. As described above, the preferred embodiment provides the correct compression ratio to be applied is calculated by means of a proportional-integral-derivative feedback loop controller such that the correct write speed of each transaction log file is calculated and short-term write speed deviations are smoothed out. In addition, the preferred embodiment also allows the user to specify that some or all of the transaction log files are not to be compressed. After variably compressing and writing the data is completed at block 306, Routine 300 proceeds to decision block 310. If it was determined at decision block 304 that the device write speeds and transmission speeds do not differ significantly, then Subroutine 300 proceeds directly to block 308 and writes more than one transaction log file.

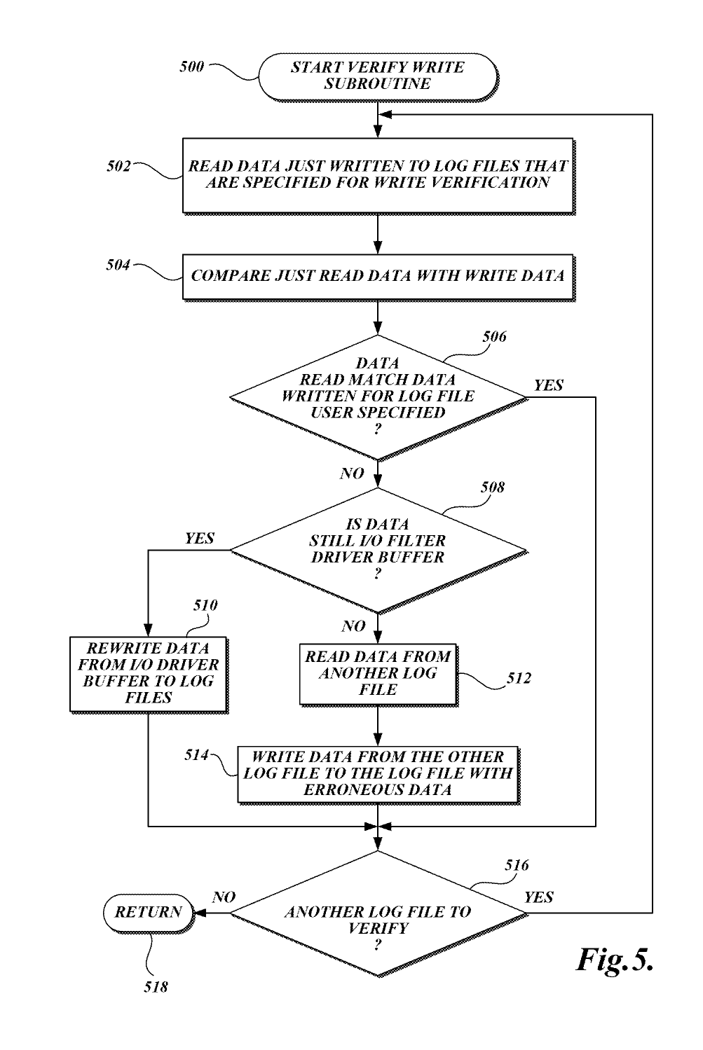

After writing the transaction log files, Subroutine 300 proceeds to decision block 310 and performs a test to determine if the user has specified the transaction log file writes to be verified. If it is determined that the user specified the verify write option for the transaction log file write, then Subroutine 300 proceeds to block 312, where the transaction log file write is verified. At block 312 the Verify Write Subroutine 500, which is discussed below with reference to FIG. 5 is performed.

In the preferred embodiment, the present invention allows the user to specify one or more transaction logs files for write verification. The write verification process will immediately perform a read of the data just written in order to ensure that the data just written has been written correctly without error in order to guarantee that one or a user selectable number of transaction log files have the correct data on their media. If an error is indeed found when the data is reread from the transaction log file then it can be rewritten either from the data still present in the IO filter driver's buffer or via a reread of one of the other transaction log files in order to gather the relevant data to be written.

As described above, in the preferred embodiment present invention increases performance and reliability of transaction log files by enabling the user to specify that immediately after the write of data to one or more specific transaction log files that the records just written should be immediately reread and compared to the data stream just written in order to verify that the data on the write media is indeed an exact copy of the data just written. In the case where the data read is found to be inconsistent with the data just written this invention can generate an alert message and perform a rewrite of the valid data and thereafter perform the same comparison again in order to check write integrity.

After verifying the transaction log file writes at block 312, Subroutine 300 proceeds to decision block 314. If it was determined at decision block 310 that the user did not specify write verification for the transaction log file writes, Subroutine 300 proceeds directly to decision block 314. At decision block 314, at test is made to determine if all transaction log file writes were successfully completed. If it is determined at decision block 314 that all transaction log file writes were successfully completed, then Subroutine 300 proceeds to directly to block 322. At block 322 a message is generated and transmitted to the operating system, reporting that the transaction log file write was successfully completed and Subroutine 300 is then completed at block 324.

If it is determined at decision block 314 that not all transaction log file writes were successfully completed, then at block 316 Subroutine 300 generates and transmits a message containing transaction log file write failure information. The message is intended to alert the database administrator or system administrator of the write failure situation. Additionally, in the preferred embodiment, Subroutine 300 can attempt a rewrite of the failed transaction log file write using the write data either from the I/O filter driver buffer if still present. Alternatively, the rewrite can be attempted using write data obtained by reading the data from another transaction log file that write data was determined to have been successfully written to. After reporting the write transaction log failure information to the system administrator or the database administrator, Subroutine 300 proceeds to decision block 318.

At decision block 318, Subroutine 300 performs a test to determine if at least two transaction log writes were successfully completed. If at least two transaction log files writes were determined to have been successfully completed then Subroutine 300 proceeds to block 322 and generates and transmits a message, reporting to the operating system that the transaction log file write request was successful and Subroutine 300 is completed at block 324. If it was determined at decision block 318 that at least two transaction log files writes were not successfully completed then Subroutine 300 proceeds to block 320 and generates and transmits a message, reporting to the operating system that the transaction log file write request was not successful. Additionally, in the preferred embodiment, Subroutine 300 can attempt a rewrite of the failed transaction log file write using the write data either from the I/O filter driver buffer if still present. Alternatively, the rewrite can be attempted using write data obtained by reading the data from another transaction log file that write data was determined to have been successfully written to. Next, Subroutine 300 is completed at block 324.

As described above. one aspect of the preferred embodiment enables the user to specify that the transaction log write request is not reported back to the operating system as complete until the writes to at least two transaction log files are successfully completed, in order to ensure at least some redundancy. In other aspects of the preferred embodiment, the invention enables the user to specify that three or more transaction files are to be written to, and should a write fail on any one of the three writes, so long as at least two or more writes are completed successfully, the transaction log write is reported back to the operating system as being successful. As described above, in the preferred embodiment, the failed write can additionally be reported as an alert to the system administrator or database administrator to be fixed at some later time. Additionally, other aspects of the preferred embodiment provide that retries of the failed write can be attempted asynchronously with the data read back from the transaction log files where the write was indeed successful.

In addition to the synchronized write log option and benefits described in detail above, the present invention provides for further increased performance and reliability of transaction log files by providing for variable asynchronous transaction log file writes. As described above with reference to FIG. 2, the I/O Filter Driver Routine 200 obtains an I/O request and performs a test at decision block 222 to determine if the user has specified variable asynchronous write. If it was determined that the user specified variable asynchronous write, then the Variable Asynchronous Write Log Subroutine 400 is performed. The Variable Asynchronous Write Log Subroutine 400 is illustrated in FIG. 4. Generally described, FIG. 4 is a flow diagram illustrating an I/O filter driver subroutine for variable asynchronous writing of a transaction log file.

Referring to FIG. 4, at block 402 Variable Asynchronous Write Log Subroutine 400 obtains user-specified information, including the total number of transaction log files the user wants written as well as the minimum number of transaction log files to be synchronously written. In accordance with the preferred embodiment, the default minimum number of transaction log files to be written is two, which includes one disparate secondary transaction log file. The user-specified total number of synchronous and asynchronous transaction log file writes and the minimum number of synchronous transaction log file writes as well as other specification information, may be obtained by reading a file storing such data. After obtaining the user specifications, at block 402, Subroutine 400 proceeds to initiate the writing of each secondary transaction log file at block 404. After initiating the writing of the secondary transaction log files at block 404, Subroutine 400 performs a test at decision block 406 to determine if the user has specified that the data just written is to be verified as having been written correctly. If it is determined that write verification has been specified for the write data, then Subroutine 400 proceeds to block 408. At block 408 write verification processing is done to ensure that the correct data was actually written to the user-specified transaction log files. The Verify Write process performed at block 408 is discussed below with reference to FIG. 5.

After verifying the writing at block 408, Subroutine 400 proceeds to decision block 410. If at decision block 406 it was determined that the user did not specify write verification for any of the write data, then Subroutine 400 proceeds directly to decision block 410. At decision block 410, at test is made to determine if all of the transaction log file writes were successfully completed. If it is determined that all of the transaction log file writes were successfully completed, including all transaction log files that were specified for write verification processing, then Subroutine 400 proceeds to block 412 where a message containing the successful transaction log file write information is generated and transmitted to the operating system. After reporting the successfully completed write to the operating system, Subroutine 400 is completed at block 414.

If at decision block 410 it was determined that not all transaction log file writes were successfully completed, then Subroutine 400 proceeds to decision block 416. At decision block 416, a test is performed to determine if both the minimum number of synchronous transaction log file writes and verified transaction log file writes were successfully completed. For the test at decision block 416 to be determined in the affirmative, the minimum number of transaction log files must have been successfully completed as well as all transaction log files the user specified for write verification must have been successfully verified. For example, consider the case where the user specifies that the minimum number of synchronous transaction log file writes is two and the user specifies a transaction log file for write verification. Then in this scenario, there must be at least two transaction log file writes that were successfully completed and one of the two transaction log file writes successfully completed must be the one specified by the user for write verification and must also have been verified as having been written correctly. The test at decision block 416 would not be affirmative if any transaction log file that the user specified for write verification was not in fact verified as having been written correctly. Even though there may be the minimum number of successfully completed synchronous transaction log file writes, there still must be successful write verification of all transaction log files specified by the user.

If at decision block 416 it is determined that the minimum number of synchronous transaction log file writes were successfully completed and all user-specified write verification transaction log files were successfully verified, then Subroutine proceeds to block 418. At block 418 Subroutine 400 generates and transmits an alert message, intended for the Database Administrator or System Administrator, containing information about asynchronous transaction log file writes that remain outstanding at that point. Recall, that since Subroutine 400 had already determined that not all transaction log file writes were successfully completed at decision block 410, but that the minimum number of synchronous transaction log file writes were successfully completed and all user-specified write verification transaction log files were successfully verified, there still remains at least one outstanding transaction log file write that has not yet been successfully completed. After generating and transmitting the alert message at block 418, Subroutine 400 proceeds to block 412 where a message to the operating system is generated and transmitted, containing successful transaction log file write information. After reporting to the operating system of the successful transaction log file write at block 412, Subroutine 400 is completed at block 414.

If at decision block 416 it was determined that the minimum number of synchronous transaction log file writes were not successfully completed or a verified write transaction log file had not been successfully verified, then Subroutine 400 proceeds to decision block 420. At decision block 420 a test is made to determine if a predefined or user-specified threshold for the maximum time interval to be allowed for writing transaction log files has been reached. If it was determined that the threshold time interval has not elapsed, then Subroutine 400 proceeds to decision block 424. At block 424, a test is made to determine if a predefined or user-specified threshold for the maximum number of outstanding transaction log writes or the maximum volume of write data allowed for writing transaction log files has been reached. If it is determined that the threshold for the maximum number of transaction log file writes or the maximum volume of write data has not been reached, then Subroutine 400 proceeds to repeat blocks 416 through 424, until either a minimum number of synchronous transaction log file writes were successfully completed and all write verification transaction log files were successfully verified, or a user-specified or predefined maximum allowed threshold has been reached.

If at decision block 420 or decision block 424, it was determined that a threshold was reached, either in terms of the maximum time interval, maximum number of outstanding transaction log file writes, and/or the maximum volume of transaction log file write data, has been reached, then Subroutine 400 proceeds to block 422. At block 422 a buffer is created for storing the outstanding transaction log file write data. Subroutine 400 proceeds to block 426 where a message containing information about the buffer storing the outstanding transaction log file write data is generated and transmitted as an alert intended for the Database Administrator or System Administrator. After generating the outstanding write data buffer message, Subroutine 400 proceeds to decision block 428 where a test is performed to determine if the buffer storing the outstanding transaction log write data has reached the maximum volume of data allowed. If so, the Subroutine 400 determines if the user has specified that the write data stored in the buffer may be written to a faster transaction log file. If it is determined that the buffer is reaching the maximum of allowed data volume and the user has specified approval for writing to a faster transaction log file, then Subroutine 400 proceeds to block 430. At block 430 Subroutine 400 artificially slows the buffer down while writing the outstanding transaction log data to the faster transaction log file as specified. In accordance with the preferred embodiment, the data for the outstanding writes to the various transaction log files are kept in a memory buffer. In the case of a system reboot, where the memory buffer has been destroyed, the outstanding write data is recreated by reading the data needed for the outstanding writes from one of the transaction log files which did not allow asynchronous writes and hence is known to be up-to-date.

After writing the write data stored in the buffer to the faster transaction log file, Subroutine 400 is completed at block 432. If at decision block 428 it was determined that the amount of write data stored in the buffer was not at the maximum level allowed, or that the user did not specify writing the outstanding data to a faster transaction log file then Subroutine 400 is completed at block 432.

As described above, the preferred embodiment provides a method for writing transaction log file data in varying degrees of asynchronous writes between the various transaction files. For example, in one scenario, the user may specify to report that the transaction log file writes are complete after the write of any transaction log reports back as complete. In the preferred embodiment, if the writes to the other outstanding transaction log files does not happen within a certain user specified elapsed time, or after a certain volume buildup of non-written data, and then a buffer of outstanding writes is created and an alert message can be generated to alert the system administrator or database administrator of this problem. Additionally, the user can specify that if this condition occurs and the outstanding write buffer contains a substantial volume of data, then the writing of log records will performed using faster transaction log files that have no write queue. In this case the present invention artificially slows the associated buffer down in order to afford the chance for the writing of unwritten transaction log records in order to “catch up”. In the preferred embodiment, the user can specify that the associated buffer is artificially slowed down by a user definable sliding duration such that the outstanding writes at the slowest transaction log can “catch up”. The preferred embodiment of the present invention additionally provides that, in the case where the user can specifies that one or more of the transaction log files be written to asynchronously after the writes to the other transaction log files have completed, the user can additionally specify that these asynchronous writes have a far higher level of compression than the compression applied to the other transaction log files.

As described above, the present invention provides increased performance and reliability of transaction log files by enabling the user to specify that the various disparate transaction log files can be completed with varying degrees of asynchronicity such that, so long as the outstanding writes to a specified transaction log do not fall behind by more than a set threshold. In the preferred embodiment, the threshold may be set in terms of the number of transaction log file writes, the total volume of write data, or a time interval. In the preferred embodiment, an alert message will not be reported as long as the outstanding transaction log file writes to not fall behind by the defined threshold. However if the number of outstanding writes (or total data size, specified interval or other defined threshold) becomes larger than a user defined amount then an alert message will be issued.

As described above, both the Synchronized Write Log Subroutine 300 and the Variable Asynchronous Write Log Subroutine 400 determine if the user has specified that the write data be verified and if so, then they perform the Write Verification Subroutine 500, which is described below with reference to FIG. 5.

Referring now to FIG. 5, generally described, is a flow diagram illustrating an I/O filter driver subroutine for verifying that the data just written to a user-specified transaction log file was in fact correctly written. At block 502, the Write Verification Subroutine 500 immediately re-reads the data that was just written to a transaction log file that was specified by the user for write verification. Subroutine 500 proceeds to block 504 and makes a comparison of the data that was just re-read with the I/O transaction write transaction log request write data still in the buffer. Subroutine 500 then proceeds to decision block 506 where a determination is made as to whether the re-read data is the same as the write data to be verified. If it is determined that the re-read data is the same as the write data, then Subroutine 500 proceeds directly to decision block 516.

If at decision block 506 it was determined that the re-read data was not the same as the write data, then Subroutine 500 proceeds to decision block 508. At decision block 508, a determination is made as to whether the write data is still in the I/O filter driver buffer. If the write data is still in the IO filter driver buffer then Subroutine 500 proceeds to block 510. At block 510, Subroutine 500 rewrites the write data from the I/O filter driver buffer to the transaction log file that was specified for write verification and that was previously determined to have incorrectly written data. After rewriting the correct data, Subroutine 500 proceeds to decision block 516.

If at decision block 508 it was determined that the write data was not still in the I/O filter driver buffer, then Subroutine 500 proceeds to block 512 where data is read from another transaction log file that the write data was previously successfully written to. Next, Subroutine 500 proceeds to block 514 and writes the data just read from the other successfully written transaction log file to the log file that was determined to have incorrect data. After writing the correct data to the transaction log file at block 516, Subroutine 500 proceeds to decision block 516.

At decision block 516 a test is performed to determine if there is another transaction log file write to verify. If so, Subroutine 500 proceeds to block 502 and repeats the process. If there are no more transaction log file writes to verify, then Subroutine 500 is completed at block 518.

As described above, the preferred embodiment enables the user to verify the correct writing of transaction log file write data to one or more specified transaction logs files. The write verification process will immediately perform a read of the data just written in order to ensure that the data just written has been written correctly without error in order to guarantee that one or a user selectable number of transaction log files have the correct data on their media. If an error is indeed found when the data is reread from the transaction log file then it can be rewritten either from the data still present in the I/O filter driver's buffer or by a re-read of one of the other transaction log files in order to gather the relevant data to be written. The preferred embodiment increases performance and reliability of transaction log files by providing for verifying writes by, immediately after the write of data to one or more specific transaction log files, re-reading and comparing the data just read to the data stream just written in order to verify that the data on the write media is indeed an exact copy of the data just written. In the case where the data read is found to be inconsistent with the data just written, in the preferred embodiment, the invention generates and transmits an alert message. The preferred embodiment then performs a rewrite of the valid data and thereafter performs the same comparison again in order to check write integrity.

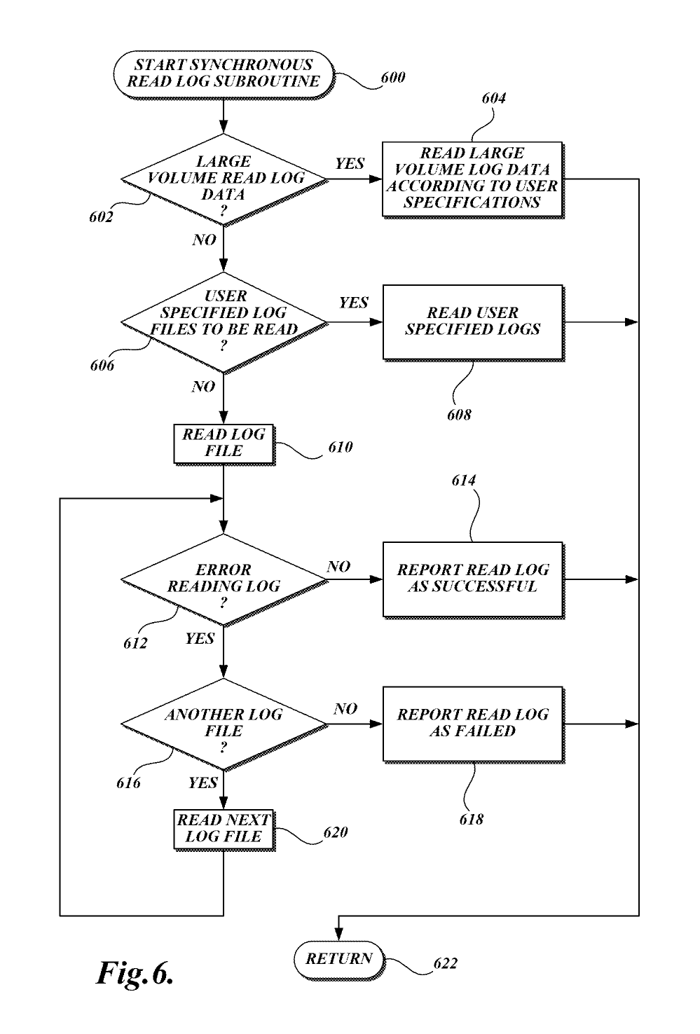

Referring to FIG. 2, the I/O Filter Driver Routine 200 obtains an I/O request at block 202. The I/O request is examined to determine if it is a DBMS read transaction log request at decision block 204. If the I/O request was determine to be a DBMS read transaction log request, then the Synchronous Read Log Subroutine 600 is performed. The Synchronous Read Log Subroutine 600 is illustrated in FIG. 6. Generally described, FIG. 6 is a flow diagram illustrating an operating system level I/O filter driver subroutine to transparently intercept read database transaction log requests for increasing performance and reliability beyond conventional single transaction log file reads. In the preferred embodiment, Subroutine 600 provides increased performance and reliability of transaction log files by determining if the read request from one transaction log file results in an error then the invention can perform the same reads from successive transaction log files until one reports a successful read, as described below.

Referring to FIG. 6, the Synchronous Read Log Subroutine 600 proceeds to decision block 602 where a test is performed to determine if the I/O request requires a large volume of transaction log data to be read, as is the case in a large recovery. If it is determined that a large volume of transaction log data is to be read, Subroutine 600 proceeds to block 604 and performs the large volume read. In accordance with the preferred embodiment, during a large recovery which may involve reading a large volume of data, the preferred embodiment allows for data read requests to be serviced from a number of different transaction log files thereby spreading the load of the reads over a number of different log files which speeds up the overall operations.

As described above for large volume transaction log reads, read performance is improved by reading from multiple transaction log files. In the preferred embodiment of the present invention, the user is provided with the ability to specify a preferred type of architecture to be utilized in performing the large volume read. In the preferred embodiment, the user can specify distributed reading using a “round-robin” or circular read architecture, a weighted “round-robin” read architecture, a fastest device read architecture, or a “read-ahead” architecture. The distributed read architectures that the user may specify for use in large volume transaction log reads are well known by those of ordinary skill in the relevant art.

In the preferred embodiment, the user can specify to perform the reads in a “round-robin” architecture where successive data is read from each transaction log file in turn. When the “round-robin” read architecture option is specified, the reads are distributed amongst the various transaction log files where each successive read is allocated to each successive transaction log file in turn.

Alternatively, the user can specify that the reads be weighted toward the faster reading devices where those faster devices are asked to read a correspondingly larger portion of the data than the slower reading devices. When the “weighted-read” architecture is specified, the transaction log files with demonstrated faster reads will be allocated a higher proportion or percentage of the volume of transaction log read requests.

The user can additionally specify that reads are always performed from the transaction log file showing the fastest average read speeds. When the “fastest read” option is specified, all reads are performed against the device which has demonstrated the fastest average read speed.

In the preferred embodiment, the user can further specify a “read-ahead” architecture whereby each of the transaction log files, or just a selection of them, are “read-ahead” of the specific read point the DBMS has requested from the log such that successive transaction log read requests by the DBMS can be serviced by data already in the filter driver cache.

As described above. the present invention provides for increased performance of transaction log files by providing the capability to distribute the large volume read loads by scheduling successive transaction log file read requests onto successive transaction log files rather than performing all reads from only one transaction log file.

In the preferred embodiment, the read-ahead feature of the present invention provides additional performance benefits by allowing the user to specify that if the round-robin read technique is selected that whilst a current read request is being satisfied by one of the transaction log files, then the invention will anticipates that the DBMS will issue successive reads against the transaction log and before those reads are even issued by the DBMS, the invention issues those read requests to successive transaction log files in the “round-robin” “circle” such that when the DBMS does indeed request those successive reads that they have already been satisfied by the invention on successive transaction log files and already reside in cache.

After performing the large volume read according to the user's specified read architecture at block 604, Subroutine 600 proceeds directly to block 622 and is completed. If at decision block 602 it was determined that there was not a large volume of transaction log data to be read, Subroutine 600 proceeds to decision block 606. At decision block 606 a test is made to determine if the user has specified that certain transaction log files are to be read. In the preferred embodiment of the invention, the user may specify that read requests are to be satisfied only from certain transaction log files. If it is determined at decision block 606 that the user specified transaction log files to be read, then Subroutine 600 proceeds to block 608 and the user-specified transaction log files are read. In accordance with the present invention, the user can request that reads take place from one or more specific transaction log file(s) as one of the other transaction log files may have corrupted data which is resulting in the DBMS issuing corrupted error messages. This technique will also be useful in segregating, isolating and improving the performance of the writes to the transaction log file by the DBMS vs. the reads from a different transaction log file needed for actions such as transactional replication etc. After reading the user-specified transaction log files at block 608, Subroutine 600 proceeds directly to block 622 and is completed.

If it was determined at decision block 606 that the user did not specify certain transaction log files to be read, then Subroutine 600 proceeds to block 610. At block 610 Subroutine 600 reads one of the two or more transaction log files that were written as described above with reference to the Synchronized Write Log Subroutine illustrated in FIG. 3 and the Asynchronous Write Log Subroutine illustrated in FIG. 4. After reading a first of the two or more transaction log files at block 610, Subroutine 600 proceeds to decision block 612. At decision block 612 a test is made to determine if an error occurred while reading the first transaction log file. If it is determined that no error occurred in reading the first transaction log file, then Subroutine 600 proceeds to block 614 and generates and transmits a message to the operating system that the read request was successfully completed. After reporting the successful read message to the operating system at block 614, Subroutine 600 proceeds directly to block 622 and is completed.

If at decision block 612 it was determined that an error did occur in reading the first transaction log file, then Subroutine 600 proceeds to decision block 616. At decision block 616 a test is made to determine if there is another transaction log file to read. In the preferred embodiment, the invention would have written at least two disparate transaction log files, unless an error occurred at which point an messages containing the write failure information would have been generated and transmitted. If it is determined that there is not another transaction log file to read, then Subroutine 600 proceeds to block 618. At block 618, Subroutine 600 generates and transmits a message to the operating system that the read transaction log request failed. After reporting the read failure message at block 618, Subroutine 600 proceeds to block 622 and is completed.

If it was determined at decision block 616 that there is another transaction log file to read, then Subroutine 600 proceeds to block 620 and reads the next transaction log file. After reading the next transaction log file at block 620, Subroutine 600 repeats blocks 612 through 620 until it is determined that either a transaction log file was successfully read or that there are no more transaction log files to read. After determining that either a transaction log file was successfully read or, that there are no more transaction log files to read, Subroutine 600 proceeds to block 622 and is completed. As described above, the present invention increases performance and reliability of reads by providing that, should an IO error be experienced during a requested read on one transaction log file, then the present invention will automatically perform the same read from successive disparate transaction log files until one of them reports a successful read, in which case the data will be returned to the DBMS successfully or they all report failure.

1. A method for utilizing an operating system level 10 filter driver for providing transparent database transaction log file redundancy, the method comprising:
intercepting a database management system write data request to said database transaction log file; and
writing said data to at least two transaction log files.

2. The method of claim 1, wherein said at least two transaction log files are stored on separate computer-readable media hardware.

3. The method of claim 1, further comprising:
determining whether writing said data to all of said at least two transaction log files was successfully completed; and
upon determining that writing said data to all of said at least two transaction log files was successfully completed, reporting to said operating system that said database management system write data request was successfully completed.

4. The method of claim 3, further comprising:
upon determining that said writing said data to all of said at least two transaction log files was not successfully completed, reporting to said operating system that said write request was not successfully completed.

5. The method of claim 3, further comprising upon determining that writing said data to all of said at least two transaction log files was not successfully completed, reporting to an administrator of said database management system that said writing was not successfully completed.

6. The method of claim 4, further comprising:
determining whether said write data is currently stored in a buffer of said IO filter driver; and
upon determining that said write data is currently stored in said JO filter driver buffer, retrying to write said write data stored in said JO filter driver buffer to said transaction log files determined to have not been successfully written to.

7. The method of claim 6, further comprising
upon determining that said write data is not currently stored in said IO filter driver buffer, determining whether one of said at least two transaction log files was successfully written to;
upon determining that one of said at least two transaction log files that was successfully written to, reading said write data from said transaction log file determined to have been successfully written to; and
retrying to write said data just read from said successfully written transaction log file to said transaction log files that were determined to have not been successfully written to.

8. The method of claim 1, further comprising:
allowing a user to specify a total number of said transaction log files to be written to, wherein said total number is more than one; and
allowing a user to specify a minimum number of synchronous transaction log file writes to be successfully completed before reporting to said operating system that said write request was successfully completed, wherein said minimum number is at least one, but less than said total number.

9. The method of claim 8, further comprising:
determining whether said minimum number of synchronous transaction log files have been successfully completed; and
upon determining that said minimum number of synchronous transaction log files were successfully written, reporting to said operating system that said write request was successfully completed.

10. The method of claim 9, further comprising allowing outstanding transaction log files beyond said minimum number to be written asynchronously after reporting to said operating system that write request was successfully completed.

11. The method of claim 10, further comprising:
allowing a user to specify highly compressing said write data for at least one of said asynchronous transaction log files writes;
determining whether the user has specified highly compressing said write data for said at least one of said asynchronous transaction log file writes; and
upon determining that the user has specified highly compressing said write data for said at least one of said asynchronous transaction log files, highly compressing said write data for said at least one of said asynchronous transaction log file writes.

12. The method of claim 10, further comprising determining whether said asynchronous writing of said outstanding transaction log files does not fall behind the synchronous writing of said minimum number of transaction log files by more than an allowed threshold.

13. The method of claim 12, wherein said threshold is specified by a user as one of:
(a) a number of write requests;
(b) a time interval;
(c) a volume of write data.

14. The method of claim 10, further comprising:
determining whether said asynchronous outstanding transaction log file writes are falling behind by more than said threshold; and
upon determining that said asynchronous outstanding transaction log file writes are falling behind by more that said threshold, reporting to an administrator of said database management system that said asynchronous outstanding transaction log file writes are falling behind by more than said threshold.

15. The method of claim 14, further comprising upon determining that said asynchronous outstanding transaction log file writes are falling behind by more than said threshold, creating a buffer for storing said asynchronous outstanding transaction log file write data.

16. The method of claim 15, further comprising:
determining whether said outstanding transaction log file write data stored in said buffer was lost; and,
upon determining said outstanding transaction log file write data stored in said buffer was lost, determining whether one other of said at least two transaction log files was successfully written to; and
upon determining that said other transaction log file was successfully written to, reading said write data from said other transaction log file to which said data was successfully written.

17. The method of claim 10, further comprising:
determining whether said asynchronous outstanding transaction log file writes has fallen behind by more than said threshold; and
upon determining that said asynchronous outstanding transaction log file writes has fallen behind by more than said threshold, slowing down subsequent writes to transaction log files by a duration of time for completing outstanding writes to all transaction log files.

18. The method of claim 17, wherein said duration is a user-specified sliding scale.

19. The method of claim 17, further comprising
determining whether all of said total number of transaction log file writes were successfully completed,
upon determining that not all of said total number of transaction log file writes were successfully completed, reporting to an administrator of said database management system that said write request was not successfully completed.

20. The method of claim 1, further comprising:
determining whether write speeds of said at least two transaction log files differ; and
upon determining that write speeds of said at least two transaction log files differ, compressing said write data to be written to said at least two transaction log files.

21. The method of claim 20, further comprising varying the amount of compression of said write data for each of said at least two transaction log files based on the difference between the write speeds of the transaction log files, where transaction log files with slower write speeds will have more highly compressed write data than transaction log files with faster write speeds.

22. The method of claim 20, further comprising allowing a user to specify one of said at least two transaction log files that will not have compressed write data.

23. The method of claim 20, wherein said varying amount of compression of said write data is calculated using a proportional-integral-derivative feedback loop controller to determine the correct write speed of each transaction log file and to smooth out short-term write speed deviations.

24. The method of claim 1, further comprising:
allowing a user to specify verifying that said write data was correctly written to at least one of said at least two transaction log files;
determining if the user has specified that said write data is to be verified as having been written correctly to one of said at least two transaction log files;
upon determining that the user has specified that said write data is to be verified as having been written correctly to said at least one of said at least two transaction log files, and immediately after writing to said at least one of said at least two transaction log files, reading data just written from said at least one of said at least two transaction log files; and
determining whether said data just read from said at least one of said at least two transaction log files is the same as said write data.

25. The method of claim 24, further comprising upon determining that said data just read is not the same as said write data, reporting to an administrator of said database management system that invalid data was written to said at least of one of said at least two transaction log files.

26. The method of claim 24, further comprising upon determining that said read data is not the same as said write data, rewriting said write data to said at least one of said at least two transaction log files determined to have invalid data.

27. The method of claim 26, further comprising:
reading said data just rewritten to said at least one transaction log file determined to have invalid data;
determining whether said data just read is the same as said write data; and
upon determining that said data just read is not the same as said write data, reporting to an administrator of said database management system that invalid data was written to said at least of one of said at least two transaction log files.

28. The method of claim 1, further comprising:
intercepting a database management system read data request from said database transaction log file; and
reading said data from one of said at least two transaction log files.

29. The method of claim 28, further comprising:
determining whether said reading of said data from said one of at least two transaction log files was successfully completed;
upon determining that said reading of said data from said one of at least two transaction log files was successfully completed, reporting to said operating system that said read data request was successfully completed.

30. The method of claim 29, further comprising upon determining said reading of said data from said one of said at least two transaction log files was not successfully completed, reading said data from a second one of said at least two transaction log files.

31. The method of claim 30, further comprising successively reading a next one of said at least two transaction log files until it is determined that said reading of said next one of said at least two transaction log files was successfully completed or that there are no more of said at least two transaction log files to read.

32. The method of claim 31, further comprising upon determining that not one of said at least two transaction log file reads was successfully completed and that there are no more of said at least two transaction log files to read, reporting to said operating system that said read data request was not successfully completed.

33. The method of claim 28, further comprising:
allowing a user to specify which one of said at least two transaction log files that said requested read data is to be read from.

34. The method of claim 28, further comprising;
determining whether said read data request is a request to read a large volume of data from said database transaction log file;
upon determining said read data request is a request to read a large volume of data from said database transaction log file, scheduling successive read requests from more than one of said at least two transaction log files for distributed reading of said requested large volume data; and
performing distributed reading by successively reading said more than one transaction log files in turn according to said schedule of reading requests.

35. The method of claim 34, wherein said distributed reading schedule of reading requests is weighted so that transaction log files with faster read speeds are allocated higher percentages of said large volume data read transaction log file requests.

36. The method of claim 34, further comprising:
allowing a user to specify a read-ahead option;
determining whether the user specified the read-ahead option;
upon determining that the user specified the read-ahead option, and while performing said distributed reading of said more than one transaction log files, anticipating the next database management system read transaction log request, and reading said anticipated database management system read transaction log request before intercepting said anticipated request, so that when said request is intercepted said requested data is already satisfied and stored in a buffer of said IO filter driver.

37. The method of claim 28, further comprising:
allowing a user to specify a fastest read option;
determining whether the user specified said fastest read option; and
upon determining that user specified said fastest read option, reading all transaction log read data requests from the one of the at least two transaction log files with the fastest read speed.

38. A method for utilizing an operating system level IO filter driver for increasing database performance, the method comprising:
intercepting a database management system write data request to said database transaction log;
determining whether the user has specified that said write data is not to be written to said transaction log file; and
upon determining that the user has specified that said write data is not to be written to said transaction log file, removing said write data from the data stream to be written to said transaction log file.

39. A method for utilizing an operating system level IO filter driver for providing database transaction log file redundancy, the method comprising:
allowing a user to specify database objects that are to be quick-logged;
intercepting a database management system write data request to said database transaction log file;
determining whether said write data contains only objects specified by the user that are to be quick-logged; and
writing said data to at least two transaction log files after reporting to said operating system that said write request was successfully completed.

40. A computer-readable medium containing computer-readable instructions, which, when executed by a computer perform the method recited in any one of claims 1-39.

41. A computer system, having a processor, a memory, and an operating environment, the computer system operable to perform the method recited in any one of claims 1-39.

42. A server computer system for providing transparent database transaction log file redundancy, the computer system comprising:
an operating system level IO filter driver;
a database component;
wherein:
said operating system level IO filter driver is operable to intercept said database management system write data requests to said database transaction log file and writing said data to at least two transaction log files.

43. The server computer system of claim 42, further comprising at least one more separate computer-readable media hardware component, wherein said computer-readable media hardware component is operable to one or more store transaction log files.

44. The server computer system of claim 42, wherein said IO filter driver is further operable to intercept said database management system read data request from said database transaction log file and reading said data from one of said at least two transaction log files.

45. The server computer system of claim 42, wherein the system includes a cache for storing large volume data reads from said database transaction log files.
